(19) United States
(12) Patent Application Publication
(10) Pub. No.: US 2002/0172353 A1
(43) Pub. Date: Nov. 21, 2002

(54) Hands-free device with electromagnetic wave shield arrangement

(76) Inventor: Hvo-Sheng Wang, Pan Chiao City (TW)

Correspondence Address: BACON & THOMAS, PLLC, 4th Floor, 625 Slaters Lane, Alexandria, VA, 22314-1176, US

(21) Appl. No.: 09/855,777

(22) Filed: May 16, 2001

(51) Int. Cl. H04M 1/00

(52) U.S. Cl. 379/420.04

(57) ABSTRACT

A hands-free device comprises a receiver having a speaker enclosed therein, a hose having one end coupled to the receiver, an enclosure at the other end of the hose and including a hole through the surface, a plug, and a first cord having one end coupled to the plug and the other end coupled to the speaker. Signals from an external communication device coupled to the plug is sent to the speaker through the first cord. The signals are then converted into voice in the speaker prior to transmitting to the enclosure through the hose. Finally, voice is outputted from the hole. Receiver is disposed away from the brain. Hence, the brain is not subject to electromagnetic wave generated by receiver while telephoning.

### FIELD OF THE INVENTION

The present invention relates to hands-free devices and more particularly to a hands-free device with electromagnetic wave shield arrangement so as to protect the brain.

### BACKGROUND OF THE INVENTION

A conventional hands-free device comprises a transmitter, a plug, a first cord coupled between transmitter and plug, a second cord formed with first cord having one end coupled to plug, and a receiver (e.g., earpiece) coupled to the other end of second cord. Hence, user may make a call through transmitter or receive a call through receiver when plug is coupled to an external communication device. It is known that electromagnetic (EM) wave is generated in receiver while telephoning. Further, receiver is held to the ear, i.e., the distance between receiver and the brain is relatively short. Hence, the brain is subject to EM emissions at this condition. As a result, such hands-free device may pose a health risk especially the brain after a long time of use.

### SUMMARY OF THE INVENTION

It is an object of the present invention to provide a hands-free device comprising a receiver having a speaker enclosed therein, a hose having one end coupled to the receiver, an enclosure at the other end of the hose and including a hole through the surface, a plug, and a first cord having one end coupled to the plug and the other end coupled to the speaker. Signals from an external communication device coupled to the plug is sent to the speaker through the first cord. The signals are then converted into voice in the speaker prior to transmitting to the enclosure through the hose. Finally, voice is outputted from the hole. Receiver is disposed away from the brain. Hence, the brain is not subject to electromagnetic wave generated by receiver while telephoning.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of hands-free device according to the invention;

FIG. 2 is an exploded view of receiver of FIG. 1;

FIG. 3 is a sectional view of enclosure of FIG. 1;

FIG. 4 is a perspective view of a second preferred embodiment of hands-free device according to the invention; and

FIG. 5 is an exploded view of receiver of FIG. 4.

### DETAILED DESCRIPTION OF THE PREFERRED EMBODIMENTS

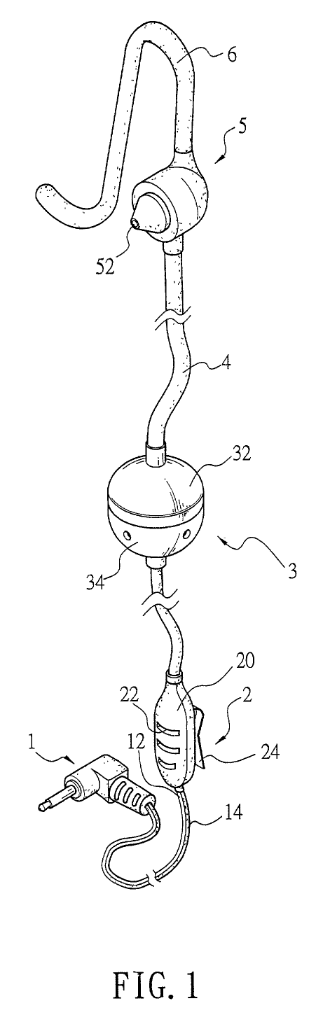

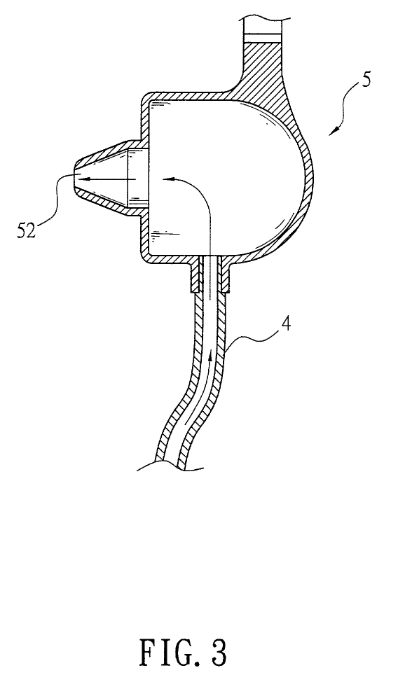

Referring to FIGS. 1 to 3, there is shown a first embodiment of hands-free device with electromagnetic wave shield arrangement constructed in accordance with the invention comprising a receiver 3, a plug 1, a first cord 14 coupled between the receiver 3 and plug 1, a hose 4 having one end coupled to the receiver 3 opposite to the first cord 14, an enclosure 5 at the other end of hose 4 and including a hole 52 through the surface, a bent section 6 having one end coupled to enclosure 5 for holding to the ear, a second cord 12 formed with first cord 14 having one end coupled to plug 1, and a transmitter 2 coupled to the other end of second cord 12. Hence, output signals from an external communication device may be sent to receiver 3 through first cord 14 when plug 1 is coupled to the communication device. Then signals are converted into voice in receiver 3 prior to transmitting to enclosure 5 through hose 4. Finally, voice is outputted from hole 52. Additionally, voice received in transmitter 2 is converted into signals. Then the signals are sent to communication device through second cord 12.

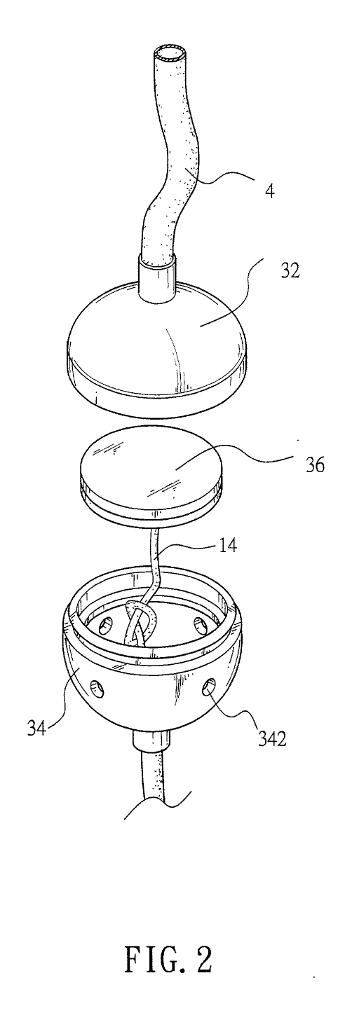

Transmitter 2 comprises a housing 20, a microphone in the space enclosed by housing 20, a plurality of slits 22 on the front surface of housing 20 for permitting voice to pass without obstruction, and a clip 24 on the rear of housing 20 for hanging on an object so as to fasten transmitter 2. The other end of second cord 12 (i.e., opposite to plug 1) is inserted into housing 20 to couple to microphone. Hence, voice received in microphone may be converted into signals. Then the signals are sent to communication device through second cord 12. Referring to FIG. 2 specifically, receiver 3 comprises an upper cover 32, a lower cover 34 conformed to upper cover 32 for forming a space therein, a speaker 36 in the space enclosed by upper cover 32 and lower cover 34, and a plurality of openings 342 through the surface of lower cover 34. Further, hose 4 has one end coupled to upper cover 32.

The other end of first cord 14 (i.e., opposite to plug 1) is passed through housing 20 of transmitter 2 to couple to speaker 36 of receiver 3. Hence, output signals from communication device are sent to speaker 36 through first cord 14. Then signals are converted into voice in speaker 36 prior to transmitting to enclosure 5 through hose 4. Finally, voice is outputted from hole 52. With this configuration, receiver 3 is disposed away from the brain. Hence, the brain is not subject to EM emissions generated by receiver 3 while telephoning.

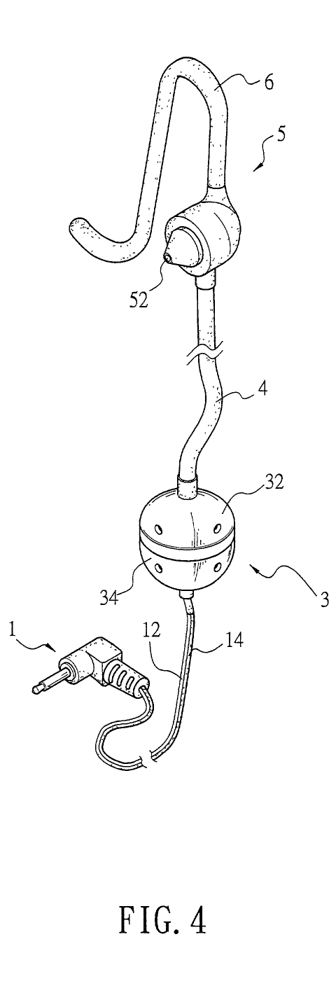

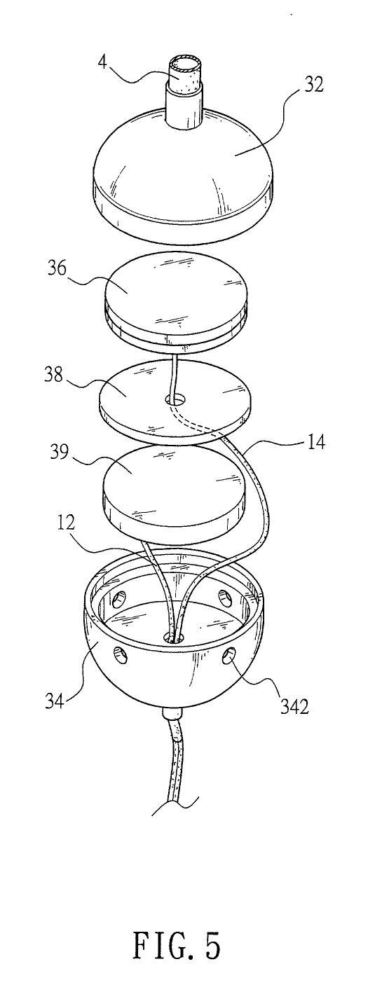

Referring to FIGS. 4 and 5, there is shown a second embodiment of hands-free device with electromagnetic wave shield arrangement constructed in accordance with the invention. The difference between first and second embodiments is that the microphone in transmitter 2 in the first embodiment is disposed in receiver 3 in the second embodiment with the elimination of transmitter 2 accordingly. Thus, the complete configuration of the hands-free device of the second embodiment is detailed as below. A speaker 36, a microphone 39, and a plate 38 for separating speaker 36 and microphone 39 are formed in a spaced enclosed by upper cover 32 and lower cover 34. The other ends of first and second cords 14 and 12 (i.e., opposite to plug 1) are passed through lower cover 34. The other end of second cord 12 is coupled to microphone 39, while first cord 14 is bypassed microphone 39 to couple to speaker 36 through the separation plate 38. A hose 4 has one end coupled to the upper cover 32 of receiver 3 opposite to lower cover 34. An enclosure 5 is located at the other end of hose 4 opposite to upper cover 32. Enclosure 5 comprises a hole 52 through the surface. A bent section 6 has one end coupled to enclosure 5 for holding to the ear.

While the invention has been described by means of specific embodiments, numerous modifications and variations could be made thereto by those skilled in the art without departing from the scope and spirit of the invention set forth in the claims.

What is claimed is:

1. A hands-free device comprising:
a receiver including an upper cover, a lower cover conformed to said upper cover for forming a space therein, and a speaker in said space enclosed by said upper and said lower covers;
a hose having one end coupled to said upper cover;
an enclosure coupled to said other end of said hose and including a hole through the surface thereof;
a plug; and
a first cord having one end coupled to said plug, and said other end passed through said lower cover and coupled to said speaker;
wherein signals from an external communication means coupled to said plug is sent to said speaker through said first cord, said signals are converted into voice in said speaker prior to transmitting to said enclosure through said hose, and voice is outputted from said hole.

2. The hands-free device of claim 1, further comprising:
a microphone in said space at the position opposite to said speaker;
a plate for separating said speaker and said microphone; and
a second cord having one end coupled to said plug and said other end passed through said lower cover and coupled to said microphone;
wherein voice received in said microphone is converted into signals which are subsequently sent to said communication means through said second cord.

3. The hands-free device of claim 1, further comprising:
a transmitter including a housing and a microphone within said housing; and
a second cord having one end coupled to said plug and said other end passed through said housing and coupled to said microphone.

4. The hands-free device of claim 3, wherein said transmitter further comprises a plurality of slits on said housing for permitting voice to pass without obstruction.

5. The hands-free device of claim 3, wherein said transmitter further comprises a clip on said housing capable of hanging on an object for fastening said transmitter.

6. The hands-free device of claim 1, further comprising a bent section having one end coupled to said enclosure for holding to ear.

7. The hands-free device of claim 1, wherein said receiver further comprises a plurality of openings on said lower cover.
